SEQUENCE LISTING (36 sequences)

SEQ ID NO: 1 - DNA, 405 bp, Artificial Sequence
  Description of Artificial Sequence Synthetic polynucleotide
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Artificial Sequence
  Description of Artificial Sequence Synthetic polypeptide
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Artificial Sequence
  Description of Artificial Sequence Synthetic polynucleotide
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Artificial Sequence
  Description of Artificial Sequence Synthetic polypeptide
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  Description of Artificial Sequence Synthetic polynucleotide
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  Description of Artificial Sequence Synthetic polypeptide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  Description of Artificial Sequence Synthetic polynucleotide
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  Description of Artificial Sequence Synthetic polypeptide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Artificial Sequence
  Description of Artificial Sequence Synthetic polynucleotide
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Artificial Sequence
  Description of Artificial Sequence Synthetic polypeptide
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  Description of Artificial Sequence Synthetic polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  Description of Artificial Sequence Synthetic polypeptide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  Description of Artificial Sequence Synthetic polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  Description of Artificial Sequence Synthetic polypeptide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Artificial Sequence
  Description of Artificial Sequence Synthetic polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Artificial Sequence
  Description of Artificial Sequence Synthetic polypeptide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Artificial Sequence
  Description of Artificial Sequence Synthetic polynucleotide
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Artificial Sequence
  Description of Artificial Sequence Synthetic polypeptide
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  Description of Artificial Sequence Synthetic polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  Description of Artificial Sequence Synthetic polypeptide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  Description of Artificial Sequence Synthetic polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  Description of Artificial Sequence Synthetic polypeptide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  Description of Artificial Sequence Synthetic polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  Description of Artificial Sequence Synthetic polypeptide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - protein, 6 aa, Artificial Sequence
  Description of Artificial Sequence Synthetic 6xHis tag
HHHHHH

SEQ ID NO: 26 - DNA, 28 bp, Artificial Sequence
  Description of Artificial Sequence Synthetic oligonucleotide
gcgcgcccatggctcaaacaggtactga

SEQ ID NO: 27 - DNA, 28 bp, Artificial Sequence
  Description of Artificial Sequence Synthetic oligonucleotide
gcagatctccagccgcgttcttgcatac

SEQ ID NO: 28 - DNA, 30 bp, Artificial Sequence
  Description of Artificial Sequence Synthetic oligonucleotide
ggccatgggattaacaataggtgtactagg

SEQ ID NO: 29 - DNA, 33 bp, Artificial Sequence
  Description of Artificial Sequence Synthetic oligonucleotide
gcagatcttacaagtgccttttgcttatattcc

SEQ ID NO: 30 - DNA, 38 bp, Artificial Sequence
  Description of Artificial Sequence Synthetic oligonucleotide
gcagcccatcagggatccctcagccttggtaccagcgc

SEQ ID NO: 31 - DNA, 50 bp, Artificial Sequence
  Description of Artificial Sequence Synthetic oligonucleotide
cccgtagctagtggatccattgaaggccgcatgaagttctccgtctccgc

SEQ ID NO: 32 - DNA, 45 bp, Artificial Sequence
  Description of Artificial Sequence Synthetic oligonucleotide
gctaagcggatccattgaaggccgcatgaagttctccattgctgc

SEQ ID NO: 33 - DNA, 30 bp, Artificial Sequence
  Description of Artificial Sequence Synthetic oligonucleotide
ccaatggggatccgaggatggagccaaggg

SEQ ID NO: 34 - DNA, 38 bp, Artificial Sequence
  Description of Artificial Sequence Synthetic oligonucleotide
ctgccattcaggggatcccatatggaggagggagacag

SEQ ID NO: 35 - DNA, 32 bp, Artificial Sequence
  Description of Artificial Sequence Synthetic oligonucleotide
cgttaaggatccgaggatgttgatgggggtgc

SEQ ID NO: 36 - DNA, 35 bp, Artificial Sequence
  Description of Artificial Sequence Synthetic oligonucleotide
gctaacagatctatgttcgcccgtctccccgtcgt

(19) United States
(12) Patent Application Publication
(10) Pub. No.: US 2009/0117796 A1
(43) Pub. Date: May 7, 2009

(54) METHOD FOR COATING FIBRE SUBSTRATE SURFACES

(75) Inventors: Thorsten Montag, Osthofen (DE); Ulf Baus, Dossenheim (DE); Marvin Karos, Schwetzingen (DE); Thomas Subkowski, Ladenburg (DE); Volker Schwendemann, Neustadt (DE); Richard Baur, Mutterstadt (DE); Christine Mendera, Dannstadt-Schauernheim (DE); Claus Bollschweiler, Heidelberg (DE); Hans-Georg Lemaire, Limburgerhof (DE); Gregor Brodt, Heppenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/916,501

(22) PCT Filed: May 31, 2006
(86) PCT No.: PCT/EP2006/062785

§ 371 Date: Dec. 4, 2007

(30) Foreign Application Priority Data
Jun. 6, 2005 (DE) 10 2005 026 143.4
Jun. 29, 2005 (DE) 10 2005 030 786.8

(51) Int. Cl. C08K 5/00; D06M 15/15; B05D 3/00; B05D 3/02

(52) U.S. Cl. 442/102; 524/17; 427/322; 427/384

(57) ABSTRACT

Fibrous substrates selected from textile substrates and leather are coated using at least one hydrophobin.

The present invention relates to a process for coating surfaces of fibrous substrates selected from textile substrates and leather by using at least one hydrophobin. The present invention further relates to coated fibrous substrates selected from textile substrates and leather and to processes for producing garments using fibrous substrates which are in accordance with the present invention.

WO 02/59413 discloses treating textile, for example polyester, polyacrylics, polyamide, with proteins or polypeptides, in particular oxidized wool dissolved in water, in order to use them with a fluffy hand. But it is a frequent observation that textiles finished according to WO 02/59413 initially have a very unpleasant hand. It is also observed that it can be difficult to achieve even application by the one-step method (page 10). To avoid this difficulty in achieving even application, a very complicated, multiple-step method utilizing epichlorohydrin is proposed as remedy. However, the use of epichlorohydrin is generally undesirable.

It is an object of the present invention to provide a process whereby the prior art disadvantages can be avoided.

We have found that this object is achieved by the process defined at the beginning.

The process defined at the beginning starts with one or more surfaces, which can be flat or textured. The surface to be coated forms part of a fibrous substrate selected from textile substrates and leather.

Textile substrates for the purposes of the present invention are textile fibers, textile intermediate and end products and finished articles manufactured therefrom which, as well as textiles for the apparel industry, also comprise for example carpets and other home textiles and also textile constructions for industrial purposes. These include unshaped constructions such as for example staples, linear constructions such as twine, filaments, yarns, lines, strings, laces, braids, cordage and also three-dimensional constructions such as for example felts, wovens, formed-loop knits, nonwovens and waddings. Textile substrates can be materials of natural origin, examples being cotton, wool or flax, or blends, for example with cotton/polyester, cotton/polyamide. Preferably, textile/textiles for the purposes of the present invention are polyacrylonitrile, polyamide and especially polyester or blends of materials of natural origin with polyacrylonitrile, polyamide and especially polyester.

Leather for the purposes of the present invention preferably refers to tanned and finished animal hides and also to so-called split leather.

Coating for the purposes of the present invention refers to a monomolecular layer of at least one hydrophobin that covers at least 10%, preferably at least 25% and more preferably at least 50% of the area of the substrate to be coated according to the present invention. The degree of coverage of fibrous substrate can be determined by conventional methods, for example by microscopic methods.

The present invention is utilizing at least one hydrophobin for coating surfaces of fibrous substrates. One hydrophobin can be used, or a mixture of a plurality of different hydrophobins.

Hydrophobins are well-known proteins, preferably small peptides, that are characteristic of filamentous fungi, for example Schizophyllum commune. They generally have eight cysteine units. Hydrophobins can be isolated from natural sources. But it is also possible to synthesize non-naturally-occurring hydrophobins by means of chemical and/or biotechnological methods of production.

The term “hydrophobins” as used herein shall preferably refer to proteins of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

where X may be any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). Each X may be the same or different. The indices next to X indicate in each case the number of amino acids, C represents cysteine, alanine, serine, glycine, methionine or threonine subject to the proviso that at least four of the amine acids identified by C are cysteine, and the indices n and m are independently natural numbers in the range from 0 to 500 and preferably in the range from 15 to 300.

One embodiment of the present invention utilizes hydrophobins which are characterized by the property (after coating of a glass surface) of increasing the contact angle of a drop of water (5 μl) by at least 20°, preferably at least 250 and more preferably 30°, compared with the contact angle formed by a drop of water of the same size with the uncoated glass surface, each measurement being carried out at room temperature.

The amino acids denoted C¹ to C⁸ are preferably cysteines; but they may also be replaced by other amino acids of similar bulk, preferably by alanine, serine, threonine, methionine or glycine. However, at least four, preferably at least five, more preferably at least six and especially at least seven of the C¹ to C⁸ positions shall consist of cysteines. Cysteines in proteins used according to the present invention may be present in reduced form or form disulfide bridges with one another. Particular preference is given to intramolecular formation of C—C bridges, in particular that involving at least one, preferably 2, more preferably three and most preferably four intramolecular disulfide bridges. In the case of the above-described exchange of cysteines for amino acids of similar bulk, it is advantageous for such C-positions to be involved in a pairwise exchange as are able to form intramolecular disulfide bridges with each other.

When cysteines, serines, alanines, glycines, methionines or threonines are used in the positions designated X, the numbering of the individual C-positions in the general formulae may change accordingly.

Preference is given to using proteins of the general formula (II)

Xₙ—C¹—X₃₋₂₅—C²—X₀₋₂—C³—X₅₋₅₀—C⁴—X₂₋₃₅—C⁵—X₂₋₁₅—C⁶—X₀₋₂—C⁷—X₃₋₃₅—C⁸—Xₘ (II)

where X, C and the indices next to X and C are each as defined above, but the indices n and m represent numbers in the range from 0 to 300, and the proteins are further distinguished by the abovementioned contact angle change, and furthermore at least six of the amino acids denoted C are cysteine. It is particularly preferable for all amino acids denoted C to be cysteine.

Preference is given to using proteins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices next to X and C are each as defined above, but the indices n and m represent numbers in the range from 0 to 200, and the proteins are further distinguished by the abovementioned contact angle change.

The residues Xₙ and Xₘ may be peptide sequences which may be naturally linked to a hydrophobin. However, either or both of the residues Xₙ and Xₘ may be peptide sequences which are not naturally linked to a hydrophobin, This also includes Xₙ and/or Xₘ residues in which a peptide sequence naturally occurring in a hydrophobin is extended by a peptide sequence not naturally occurring in a hydrophobin.

When Xₙ and/or Xₘ are peptide sequences which are not naturally linked to hydrophobins, the length of such sequences is generally at least 20 amino acids, preferably at least 35 amino acids, more preferably at least 50 amino acids and most preferably at least 100 amino acids. A residue of this kind, which is not naturally linked to a hydrophobin, will also be referred to as a fusion partner portion hereinbelow. This is intended to articulate the fact that proteins used according to the present invention may consist of at least one hydrophobin portion and a fusion partner portion which do not occur together in this form in nature.

The fusion partner portion may be selected from a multiplicity of proteins. It is also possible for a plurality of fusion partner portions to be linked to one hydrophobin portion, for example to the amino terminus (Xₙ) or to the carboxy terminus (Xₘ) of the hydrophobin portion. But it is also possible, for example, to link two fusion partner portions to one position (Xₙ or Xₘ) of the protein used according to the present invention.

Particularly suitable fusion partner portions are proteins which occur naturally in microorganisms, in particular in E. coli or Bacillus subtilis, Examples of such fusion partner portions are the sequences yaad (SEQ ID NO:15 and 16), yaae (SEQ ID NO:17 and 18) and thioredoxin. Also highly suitable are fragments or derivatives of the aforementioned sequences which comprise only a portion, preferably 70% to 99% and more preferably 80% to 98%, of the said sequences, or in which individual amino acids or nucleotides have been altered compared with the sequence mentioned, the percentages all being based on the number of amino acids.

Proteins used according to the present invention may additionally be modified in their polypeptide sequence, for example by glycosylation, acetylation or else by chemical crosslinking, for example with glutaraldehyde.

One property of the proteins used according to the present invention is the change in surface properties when the surfaces are coated with the proteins. The change in surface properties can be determined experimentally by measuring the contact angle of a drop of water before and after coating of the surface with the protein and determining the difference between the two measurements.

A person skilled in the art will know in principle how to perform contact angle measurements. The precise experimental conditions for an illustrative method of measuring the contact angle are described in the experimental portion.

The positions of the polar and apolar amino acids in the hydrophobin portion of the hydrophobins known to date are preserved, resulting in a characteristic hydrophobicity plot. Differences in biophysical properties and hydrophobicity led to the hydrophobins known to date being classified in two classes, I and II (Wessels et al., Ann. Rev. Phytopathol., 1994, 32, 413-437).

The assembled membranes of class I hydrophobins are highly insoluble (even in a 1% by weight aqueous solution of sodium n-dodecyl sulfate (SDS) at an elevated temperature such as 80° C. for example) and can only be dissociated again by means of concentrated trifluoroacetic acid (TFA) or formic acid. In contrast, the assembled forms of class II hydrophobins are less stable. They can be dissolved again by means of just 60% by weight ethanol or 1% by weight SDS (each in water, at room temperature).

Comparison of the amino acid sequences reveals that the length of the region between cysteine C³ and cysteine C⁴ is distinctly shorter in class II hydrophobins than in class I hydrophobins. Class II hydrophobins further have more charged amino acids than class I.

Particularly preferred hydrophobins for embodying the present invention are those of the type dewA, rodA, hypA, hypB, sc3, basf1, basf2, which are structurally characterized in the sequence listing below. They may also be only parts or derivatives thereof. It is also possible to link a plurality of hydrophobin portions, preferably 2 or 3, of the same or a different structure together and to a corresponding suitable polypeptide sequence which is not naturally connected to a hydrophobin.

Of particular suitability for the practice of the present invention are further the fusion proteins having the polypeptide sequences indicated in SEQ ID NO: 20, 22, 24 and also the nucleic acid sequences coding therefor, in particular the sequences according to SEQ ID NO: 19, 21, 23. Particularly preferred embodiments further include proteins which, starting from the polypeptide sequences indicated in SEQ ID NO. 22, 22 or 24, result from the substitution, insertion or deletion of at least one, up to 10, preferably 5, more preferably 5% of all amino acids and which still possess at least 50% of the biological property of the starting proteins. Biological property of the proteins used according to the present invention is herein to be understood as meaning the above-described change in the contact angle by at least 20°.

Proteins used according to the present invention are chemically preparable by familiar techniques of peptide synthesis, for example by Merrifield's solid phase synthesis.

Naturally occurring hydrophobins can be isolated from natural sources using suitable methods. As an example, see Wösten et. al., Eur. J. Cell Bio. 63, 122-129 (1994) or WO 96/41882.

Fusion proteins are preferably preparable by genetic engineering processes in which one nucleic acid sequence, in particular a DNA sequence, coding for the fusion partner and one nucleic acid sequence, in particular a DNA sequence, coding for the hydrophobin portion are combined such that the desired protein is generated in a host organism by gene expression of the combined nucleic acid sequence. Such a method of making is disclosed in our prior application DE 102005007480.4.

Suitable host, or producer, organisms for the method of making mentioned include prokaryotes (including Archaea) or eukaryotes, particularly bacteria including halobacteria and methanococci, fungi, insect cells, plant cells and mammalian cells, more preferably Escherichia coli, Bacillus subtilis, Bacillus megaterium, Aspergillus oryzea, Aspergillus nidulans, Aspergillus niger, Pichia pastoris, Pseudomonas spec., lactobacilli, Hansenula polymorpha, Trichoderma reesei, SF9 (or related cells), and so on.

Useful hydrophobins for the present invention further include expression constructs comprising, under the genetic control of regulatory nucleic acid sequences, a nucleic acid sequence coding for a protein used according to the present invention, and also vectors comprising at least one of these expression constructs.

Expression constructs used preferably comprise a promoter 5′ upstream of the particular coding sequence and a terminator sequence 3′ downstream of the particular coding sequence and also, if appropriate, further customary regulatory elements, each operatively linked to the coding sequence.

“Operative linkage” refers to the sequential arrangement of promoter, coding sequence, terminator and, if appropriate, further regulatory elements such that each of the regulatory elements is able to fulfill its function as required in expressing the coding sequence.

Examples of operatively linkable sequences are targeting sequences and also enhancers, polyadenylation signals and the like. Further regulatory elements comprise selectable markers, amplification signals, origins of replication and the like. Suitable regulatory sequences are described for example in Goeddel, Gene Expression Technology: Methods in Enzymology 185, Academic Press, San Diego, Calif. (1990).

In addition to these regulatory sequences, the natural regulation of these sequences may still be present upstream of the actual structural genes and, if appropriate, may have been genetically modified such that the natural regulation has been switched off and the expression of the genes has been enhanced.

A preferred nucleic acid construct advantageously also comprises one or more of the aforementioned enhancer sequences which are functionally linked to the promoter and which enable an enhanced expression of the nucleic acid sequence. Additional advantageous sequences such as further regulatory elements or terminators may also be inserted at the 3′ end of the DNA sequences.

The nucleic acids may be present in the construct in one or more copies. The construct may further comprise additional markers such as antibiotic resistances or auxotrophy-complementing genes, if appropriate for the purpose of selecting said construct.

Advantageous regulatory sequences for the process are present for example in promoters such as cos, tac, trp, tet, trp, tet, lpp, lac, lpp-lac, laclq-T7, T5, T3, gal, trc, ara, rhaP(rhaPBAD) SP6, lambda-PR or imlambda-P promoter, which promoters are advantageously used in Gram-negative bacteria. Further advantageous regulatory sequences are present for example in the Gram-positive promoters amy and SP02, in the yeast or fungal promoters ADC1, MFalpha, AC, P-60, CYC1, GAPDH, TEF, rp28, ADH.

It is also possible to use artificial promoters for regulation.

To express the nucleic acid construct in a host organism, it is advantageously inserted in a vector, for example a plasmid or phage, which permits optimal expression of the genes in the host. Vectors, as well as plasmids and phages, further include all other vectors known per se, i.e., for example viruses, such as SV40, CMV, baculovirus and adenovirus, transposons, IS elements, phasmids, cosmids, and linear or circular DNA, and also the Agrobacterium system.

These vectors may be replicated autonomously in the host organism or chromosomally. These vectors constitute a further form of the invention. Examples of suitable plasmids are, in E. coli, pLG338, pACYC184, pBR322, pUC18, pUC19, pKC30, pRep4, pHS1, pKK223-3, pDHE19.2, pHS2, pPLc236, pMBL24, pLG200, pUR290, pIN-III″3-B1, tgt11 or pBdCI, in Streptomyces, pIJ101, pIJ364, pIJ702 or pIJ361, in Bacillus pUB110, pC194 or pBD214, in Corynebacterium pSA77 or pAJ667, in fungi pALS1, pIL2 or pBB116, in yeasts 2alpha, pAG-1, YEp6, YEp13 or pEMBLYe23 or in plants pLGV23, pGHlac+, pBIN19, pAK2004 or pDH51. The plasmids mentioned constitute a small selection of the possible plasmids. Further plasmids are known per se and are to be found for example in the book Cloning Vectors (Eds. Pouwels P. H. et al. Elsevier, Amsterdam-New York-Oxford, 1985, ISBN 0 444 904018).

To express the other genes which are present, the nucleic acid construct advantageously further comprises 3′- and/or 5′-terminal regulatory sequences to enhance expression which are selected for optimal expression according to the choice of host organism and gene or genes.

These regulatory sequences are intended to enable the genes and protein expression to be specifically expressed. Depending on the host organism, this may mean for example that the gene is expressed or overexpressed only after induction, or that it is expressed and/or overexpressed immediately.

It is preferably the expression of the genes which have been introduced which may be positively influenced and thereby enhanced by the regulatory sequences or factors. The regulatory elements may thus be advantageously enhanced on the transcription level by using strong transcription signals such as promoters and/or enhancers. However, in addition to this, it is also possible to enhance translation by improving the stability of the mRNA for example.

In a further form of the vector, the vector comprising the nucleic acid construct or the nucleic acid may also advantageously be introduced into the microorganisms in the form of a linear DNA and be integrated into the genome of the host organism via heterologous or homologous recombination. This linear DNA may consist of a linearized vector such as a plasmid or only of the nucleic acid construct or the nucleic acid.

For optimal expression of heterologous genes in organisms it is advantageous to modify the nucleic acid sequences in accordance with the specific codon usage utilized in the organism. The codon usage can readily be determined with the aid of computer analyses of other known genes of the organism in question.

An expression cassette is prepared by fusing a suitable promoter to a suitable coding nucleotide sequence and to a terminator or polyadenylation signal. Common recombination and cloning techniques as described for example in T. Maniatis, E. F. Fritsch and J. Sambrook, Molecular Cloning: A Laboratory Manual, Cold Spring Harbor Laboratory, Cold Spring Harbor, N.Y. (1989) and also in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in Molecular Biology, Greene Publishing Assoc. and Wiley Interscience (1987), are used for this purpose.

To achieve expression in a suitable host organism, the recombinant nucleic acid construct, or gene construct, is advantageously inserted into a host-specific vector which provides optimal expression of the genes in the host. Vectors are known per se and may be taken for example from “Cloning Vectors” (Pouwels P. H. et al., Eds, Elsevier, Amsterdam-New York-Oxford, 1985).

It is possible to prepare, with the aid of the vectors, recombinant microorganisms which are, for example, transformed with at least one vector and which may be used for producing the proteins used according to the invention. Advantageously, the above-described recombinant expression constructs are introduced into a suitable host system and expressed. In this connection, familiar cloning and transfection methods known to the skilled worker, such as, for example, coprecipitation, protoplast fusion, electroporation, retroviral transfection and the like, are preferably used in order to cause said nucleic acids to be expressed in the particular expression system. Suitable systems are described, for example, in Current Protocols in Molecular Biology, F. Ausubel et al., Eds., Wiley Interscience, New York 1997, or Sambrook et al. Molecular Cloning: A Laboratory Manual. 2nd edition, Cold Spring Harbor Laboratory, Cold Spring Harbor Laboratory Press, Cold Spring Harbor, N.Y., 1989.

It is also possible to prepare homologously recombined microorganisms. For this purpose, a vector which comprises at least one section of a gene to be used according to the invention or of a coding sequence in which, if appropriate, at least one amino acid deletion, amino acid addition or amino acid substitution has been introduced in order to modify, for example functionally disrupt, the sequence (knockout vector), is prepared. The introduced sequence may, for example, also be a homolog from a related microorganism or be derived from a mammalian, yeast or insect source. Alternatively, the vector used for homologous recombination may be designed in such a way that the endogenous gene is, in the case of homologous recombination, mutated or otherwise altered but still encodes the functional protein (e.g. the upstream regulatory region may have been altered in such a way that expression of the endogenous protein is thereby altered). The altered section of the gene used according to the invention is in the homologous recombination vector. The construction of vectors which are suitable for homologous recombination is described, for example, in Thomas, K. R. and Capecchi, M. R. (1987) Cell 51:503.

Recombinant host organisms suitable for the nucleic acid used according to the invention or the nucleic acid construct are in principle any prokaryotic or eukaryotic organisms. Advantageously, microorganisms such as bacteria, fungi or yeasts are used as host organisms. Gram-positive or Gram-negative bacteria, preferably bacteria of the families Enterobacteriaceae, Pseudomonadaceae, Rhizobiaceae, Streptomycetaceae or Nocardiaceae, particularly preferably bacteria of the genera Escherichia, Pseudomonas, Streptomyces, Nocardia, Burkholderia, Salmonella, Agrobacterium or Rhodococcus, are advantageously used.

The organisms used in the process of preparing fusion proteins are, depending on the host organism, grown or cultured in a manner known to the skilled worker. Microorganisms are usually grown in a liquid medium which comprises a carbon source, usually in the form of sugars, a nitrogen source, usually in the form of organic nitrogen sources such as yeast extract or salts such as ammonium sulfate, trace elements such as iron salts, manganese salts and magnesium salts and, if appropriate, vitamins, at temperatures of between 0° C. and 100° C., preferably between 10° C. and 60° C., while being supplied with oxygen. In this connection, the pH of the nutrient liquid may be kept at a fixed value, i.e. may or may not be regulated during cultivation. The cultivation may be carried out batchwise, semibatchwise or continuously. Nutrients may be initially introduced at the beginning of the fermentation or be fed in subsequently in a semicontinuous or continuous manner. The enzymes may be isolated from the organisms by the process described in the examples or be used for the reaction as a crude extract.

Also suitable are processes for recombinantly preparing proteins used according to the invention or functional, biologically active fragments thereof, with a protein-producing microorganism being cultured, expression of the proteins being induced if appropriate and said proteins being isolated from the culture. Proteins used according to the invention may also be produced in this way on an industrial scale if this is desired. The recombinant microorganism may be cultured and fermented by known methods. Bacteria may, for example, be propagated in TB medium or LB medium and at a temperature of from 20 to 40° C. and a pH of from 6 to 9. Suitable culturing conditions are described in detail, for example, in T. Maniatis, E. F. Fritsch and J. Sambrook, Molecular Cloning: A Laboratory Manual, Cold Spring Harbor Laboratory, Cold Spring Harbor, N.Y. (1989).

If protein used according to the invention is not secreted into the culture medium, the cells are then disrupted and the product is obtained from the lysate by known protein isolation processes. The cells may be disrupted, as desired, by means of high-frequency ultrasound, by means of high pressure, such as, for example, in a French pressure cell, by means of osmolysis, by the action of detergents, lytic enzymes or organic solvents, by means of homogenizers or by a combination of two or more of the processes listed.

Protein used according to the invention may be purified using known chromatographic methods such as molecular sieve chromatography (gel filtration), such as Q Sepharose chromatography, ion exchange chromatography and hydrophobic chromatography, and also using other customary methods such as ultrafiltration, crystallization, salting-out, dialysis and native gel electrophoresis. Suitable processes are described, for example, in Cooper, F. G., Biochemische Arbeitsmethoden, Verlag Walter de Gruyter, Berlin, New York or in Scopes, R., Protein Purification, Springer Veriag, New York, Heidelberg, Berlin.

It may be advantageous to isolate the recombinant protein by using vector systems or oligonucleotides which extend the cDNA by particular nucleotide sequences and thereby code for altered polypeptides or fusion proteins which are used, for example, to simplify purification. Examples of suitable modifications of this kind are “tags” acting as anchors, such as the modification known as the hexa-histidine anchor, or epitopes which can be recognized as antigens by antibodies (described, for example, in Harlow, E. and Lane, D., 1988, Antibodies: A Laboratory Manual. Cold Spring Harbor (N.Y.) Press). Other suitable tags are, for example, HA, calmodulin-BD, GST, MBD; chitin-BD, steptavidin-BD-avi-tag, Flag-tag, T7 etc. These anchors may be used for attaching the proteins to a solid support such as a polymer matrix, for example, which may, for example, be packed in a chromatography column, or may be used on a microtiter plate or on another support. The corresponding purification protocols can be obtained from the commercial affinity tag suppliers.

The proteins prepared as described may be used either directly as fusion proteins or, after cleaving off and removing the fusion partner portion, as “pure” hydrophobins. When removal of the fusion partner portion is intended, it is advisable to incorporate a potential cleavage site (specific recognition sites for proteases) in the fusion protein between the hydrophobin portion and the fusion partner portion. Suitable cleavage sites include in particular those peptide sequences which otherwise occur neither in the hydrophobin portion nor in the fusion partner portion, as is readily determined by means of bioinformatics tools. Particularly suitable are for example BrCN cleavage on methionine or protease-mediated cleavage with factor Xa, enterokinase cleavage, thrombin, TEV (tobacco etch virus) protease cleavage.

Hydrophobins can be used in substance when they are used according to the present invention for coating surfaces. Preferably the hydrophobins are used in aqueous formulation.

The choice of hydrophobins to embody the invention is basically unrestricted. It is possible to use one hydrophobin or else a plurality of different ones. For example, it is possible to use fusion proteins such as for example yaad-Xa-dewA-his (SEQ ID NO: 19) or yaad-Xa-rodA-his (SEQ ID NO: 21).

Hydrophobins as described above are used according to the present invention for coating surfaces of fibrous substrates selected from textile substrates and leather.

Hydrophobins as described above may be used according to the present invention for coating surfaces of fibrous substrates selected from textile substrates and leather without having to resort to strongly alkylating compounds such as epichlorohydrin or to crosslinkers such as DMDHEU for example.

The present invention further provides a process for coating fibrous substrates selected from textile substrates and leather by using at least one hydrophobin. Hydrophobins, fibrous substrates, textile substrates and leather and also coating are all as defined above.

In one embodiment of the present invention the process of the present invention is carried out by contacting fibrous substrate to be coated with at least one aqueous formulation, preferably an aqueous liquor, comprising at least one hydrophobin.

The liquor ratio may be for example in the range from 10:1 to 1000:1 and preferably in the range from 70:1 to 500:1.

One embodiment of the present invention comprises contacting fibrous substrate to be coated with at least one aqueous formulation, preferably an aqueous liquor, comprising at least one hydrophobin by the exhaust process.

Another embodiment of the present invention comprises contacting fibrous substrate to be coated with at least one aqueous formulation, preferably an aqueous liquor, comprising at least one hydrophobin by a padding process.

One embodiment of the present invention comprises contacting fibrous substrate in particular textile substrate with hydrophobin for example in a tank or preferably by means of a pad mangle.

One embodiment of the present invention comprises contacting fibrous substrate in particular textile substrate with hydrophobin at temperatures in the range from 0° C. to 90° C. and preferably in the range from room temperature to 85° C.

One embodiment of the present invention comprises fibrous substrate in particular textile substrate being contacted with hydrophobin for example in a tank or preferably by means of a pad mangle and subsequently dried, for example at temperatures in the range from 20 to 120° C.

One embodiment of the present invention comprises fibrous substrate in particular textile substrate being contacted with hydrophobin for example in a tank or preferably by means of a pad mangle and subsequently dried, for example at temperatures in the range from 20 to 120° C., and for example for a period in the range from 5 seconds to 15 minutes and preferably up to 5 minutes. Suitable drying temperatures range for example from 20° C. to 120° C. and preferably up to 105° C. The lower the temperature the longer the drying time, and vice versa.

To contact fibrous substrate with hydrophobin by means of a pad mangle according to the present invention, it is possible for example to choose application speeds in the range from 0.1 to 10 m/min and preferably in the range from 1 to 5 m/min and a contact pressure in the range from 0.5 to 4 bar and preferably in the range from 1 to 3 bar for the rolls.

One embodiment of the present invention comprises contacting fibrous substrate in particular leather with hydrophobin by covering fibrous substrate, for example by spraying, with an aqueous formulation comprising at least one hydrophobin one or more times.

An aqueous formulation may act on fibrous substrate for example in the range from 1 to 24 hours and preferably from 12 to 17 hours.

Aqueous formulation employed in the process of the present invention is preferably prepared using water as a solvent or mixtures of water and water-miscible organic solvents. Examples of water-miscible organic solvents comprise water-miscible monohydric or polyhydric alcohols, for example methanol, ethanol, n-propanol, i-propanol, ethylene glycol, propylene glycol or glycerol. They may also be ether alcohols. Examples comprise monoalkyl ethers of (poly)ethylene or (poly)propylene glycols such as ethylene glycol monobutyl ether. The identity and amount of the water-soluble organic solvents are not critical themselves and can be for example in the range from 1% to 50% by weight, based on aqueous formulation used according to the present invention.

Aqueous formulations used for carrying out the process of the present invention may further comprise from 0.1 to 5% by weight of inorganic salt, for example NaCl, based on aqueous formulation used according to the present invention.

One preferred embodiment of the present invention comprises not using strongly alkylating compounds such as epichlorohydrin to carry out the process of the present invention.

One preferred embodiment of the present invention comprises not using crosslinkers such as for example N,N-dimethylol-4,5-dihydroxyethyleneurea (DMDHEU) to carry out the process of the present invention.

To prepare aqueous formulation and preferably liquor used in the process of the pre-sent invention it may be preferable to employ the as-synthesized, as-isolated and/or as-purified aqueous hydrophobin solutions. These may still comprise, depending on their purity, residues of auxiliaries from the synthesis. But it is also possible of course to isolate the hydrophobins initially as a substance, for example by freeze drying, and for them only to be formulated in a second step.

The requisite concentration of hydrophobin in aqueous formulation used in the process of the present invention can be determined according to the identity of the surface to be coated and/or the planned use. But even comparatively low concentrations of hydrophobin will be sufficient to achieve the intended effect.

In one embodiment of the present invention the process of the present invention utilizes at least one aqueous formulation comprising from 1 mg/l to 10 g/l of at least one hydrophobin.

In one embodiment of the present invention aqueous formulation and especially liquor used in the process of the present invention has a pH in the range from 3 to 9 and preferably in the range from 4 to 8.

One embodiment of the present invention comprises fibrous substrate to be coated to be pretreated prior to the contacting with hydrophobin and only then to be contacted with hydrophobin.

An example of a pretreatment is to rinse for several minutes with water, preferably with completely ion-free water, more preferably for a period in the range from 5 minutes to 5 hours.

One embodiment of the present invention comprises pretreating fibrous substrate surface to be coated according to the present invention by contacting it with another aqueous formulation comprising at least one active substance. Active substance can be selected from organic chemicals, for example from anionic, cationic or nonionic detergents, or from enzymes such as for example proteases or lipases.

One embodiment of the present invention comprises pretreating according to the pre-sent invention by bleaching fibrous substrate to be coated according to the present invention. This embodiment is preferred when fibrous substrate to be coated comprises cotton or cotton-synthetic fiber blends.

Aqueous formulation used according to the present invention may optionally further comprise further components, for example additives and/or auxiliaries. Examples of such components comprise acids or bases, for example carboxylic acids or ammonia, buffering systems, polymers, inorganic particles such as SiO₂ or silicates, colorants such as for example dyes, scents or biocides. Further examples of additives are recited in DE-A 101 60 993, especially sections [0074] to [0131].

The process of the present invention provides a coated surface of fibrous substrate and preferably coated textile substrate or leather comprising a soil-repellent coating comprising at least one hydrophobin.

The coating generally comprises at least one monomolecular layer of hydrophobin on the coated surface.

Fibrous substrate surfaces treated according to the present invention, fibrous substrates being selected from textile substrates and leather, not only have an improved fluffy hand and a visually uniform coating, but also are soil repellent.

Soil refers as usual to any kind of undesired contamination of hard surfaces with solid and/or liquid entities. Examples of soil comprise fats, oils, proteins, food residues, dust or earth. But soil may also comprise lime deposits such as for example dried tracks of water which form by reason of water hardness. Further examples comprise residues of cleaning and caring compositions for person care or else insoluble lime soaps which can form from such cleaning and caring compositions in conjunction with water hardness and which may form deposits on surfaces of fibrous substrates such as for example textile substrates or leather.

The soil-repellent effect can be determined by means of principally known methods, for example by comparing the detachability of soil by rinsing off with water for an untreated surface against a surface treated with hydrophobins.

Aqueous formulations used according to the present invention can be produced for example by mixing one or more hydrophobins with water and/or one or more of the aforementioned solvents. If desired, further components, for example additives and/or auxiliaries, can be added, in which case the order in which hydrophobin and water, if appropriate solvents and if appropriate one or more further components are added is not critical.

Formulations according to the present invention are generally free of strongly alkylating compounds such as epichlorohydrin or crosslinkers such as for example DMDHEU and storable for long periods without decomposition.

The present invention further provides fibrous substrates selected from textile substrates and leather coated by the above-described process according to the present invention. They possess not only excellent soil-repellent properties, but also good wash and rub fastnesses and also a pleasant hand. They are useful for example for producing home textiles such as for example bedding, drapes and curtains, bath and sanitary textiles and also tablecloths, further for producing textiles for the outdoor sector such as for example awnings, tents, boat covers, truck tarpaulins, cabriolet roofs and especially for producing apparel items such as for example shoes, jackets, coats, pants, pullovers, stockings, belts, also home textiles such as for example bedding, drapes and curtains, bath and sanitary textiles and also tablecloths. Leathers coated according to the present invention are particularly useful for producing apparel items such as boots, also for producing empty articles for industrial use.

The examples which follow illustrate the invention:

### Part A:

### Preparation and Testing of Hydrophobins Used According to Invention

### EXAMPLE 1

### Preliminary Work for the Cloning of yaad-His₆/yaaE-His₆

A polymerase chain reaction was carried out with the aid of the oligonucleotides Hal570 and Hal571 (Hal 572/Hal 573). The template DNA used was genomic DNA of the bacterium Bacillus subtilis. The PCR fragment obtained comprised the coding sequence of the Bacillus subtilis yaaD/yaaE gene and, at their termini, in each case an NcoI and, respectively, BgIII restriction cleavage site. The PCR fragment was purified and cut with the restriction endonucleases NcoI and BgIII. This DNA fragment was used as insert and cloned into the vector pQE60 from Qiagen, which had previously been linearized with the restriction endonucleases NcoI and BgIII. The vectors thus obtained, pQE60YAAD#2/pQE60YaaE#5, may be used for expressing proteins consisting of YAAD::HIS₆ and YAAE::HIS₆, respectively.

HaI570: gcgcgcccatggctcaaacaggtactga
HaI571: gcagatctccagccgcgttcttgcatac
HaI572: ggccatgggattaacaataggtgtactagg
HaI573: gcagatcttacaagtgccttttgcttatattcc

### EXAMPLE 2

### Cloning of yaad Hydrophobin DewA-His₆

A polymerase chain reaction was carried out with the oligonucleotide KaM 416 and KaM 417. The template DNA used was genomic DNA of the mold Aspergillus nidulans. The PCR fragment obtained comprised the coding sequence of the hydrophobin gene dewA and an N-terminal factor Xa proteinase cleavage site. The PCR fragment was purified and cut with the restriction endonuclease BamHI. This DNA fragment was used as insert and cloned into the pQE60YAAD#2 vector previously linearized with the restriction endonuclease BgIII.

The vector thus obtained, #508, may be used for expressing a fusion protein consisting of YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTCTCCGC

### EXAMPLE 3

### Cloning of yaad Hydrophobin RodA-His₆

The plasmid #513 was cloned analogously to plasmid #508, using the oligonucleotides KaM 434 and KaM 435.

KaM434:
GCTAAGCGGATCCATTGAAGGCCGCATGAAGTTCTCCATTGCTGC
KaM435:
CCAATGGGGATCCGAGGATGGAGCCAAGGG

### EXAMPLE 4

### Cloning of yaad Hydrophobin BASF1-His₆

The plasmid #507 was cloned analogously to plasmid #508, using the oligonucleotides KaM 417 and KaM 418. The template DNA employed was an artificially synthesized DNA sequence—hydrophobin BASF1 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### EXAMPLE 5

### Cloning of yaad Hydrophobin BASF2-His₆

The plasmid #506 was cloned analogously to plasmid #508, using the oligonucleotides KaM 417 and KaM 418. The template DNA employed was an artificially synthesized DNA sequence—hydrophobin BASF2 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### EXAMPLE 6

### Cloning of yaad Hydrophobin SC3-His₆

The plasmid #526 was cloned analogously to plasmid #508, using the oligonucleotides KaM464 and KaM465. The template DNA employed was Schyzophyllum commune cDNA (see appendix).

KaM464: CGTTAAGGATCCGAGGATGTTGATGGGGGTGC
KaM465: GCTAACAGATCTATGTTCGCCCGTCTCCCCGTCGT

### EXAMPLE 7

### Fermentation of the Recombinant E. coli Strain yaad Hydrophobin DewA-His₆

Inoculation of 3 ml of LB liquid medium with an E. coli strain expressing yaad hydrophobin DewA-His₆ in 15 ml Greiner tubes. Incubation on a shaker at 200 rpm at 37° C. for 8 h. In each case 2 1 l Erlenmeyer flasks with baffles and 250 ml of LB medium (+100 μg/ml ampicillin) were inoculated with 1 ml of preculture and incubated on a shaker at 180 rpm at 37° C. for 9 h. Inoculate 13.5 l of LB medium (+100 μg/ml ampicillin) with 0.5 l of preculture (OD₆₀₀ₙₘ 1:10 measured against H₂O) in a 20 l fermenter. Addition of 140 ml of 100 mM IPTG at an OD₆₀ₙₘ of ˜3.5. After 3 h, cool fermenter to 10° C. and remove fermentation broth by centrifugation. Use cell pellet for further purification.

### EXAMPLE 8

### Purification of the recombinant hydrophobin fusion protein (purification of hydrophobin fusion proteins possessing a C-terminal His6 tag)

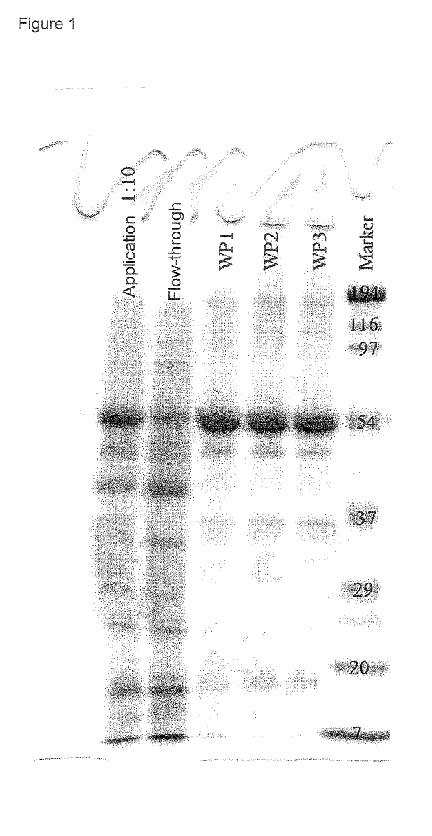

100 g of cell pellet (100-500 mg of hydrophobin) were made up with 50 mM sodium phosphate buffer, pH 7.5, to a total volume of 200 ml and resuspended. The suspension was treated with an Ultraturrax type T25 (Janke and Kunkel; IKA-Labortechnik) for 10 minutes and subsequently, for the purposes of degrading the nucleic acids, incubated with 500 units of benzonase (Merck, Darmstadt; order No. 1.01697.0001) at room temperature for 1 hour. Prior to cell disruption, a filtration was carried out using a glass cartridge (P1). For the purposes of disrupting the cells and of shearing of the remaining genomic DNA, two homogenizer runs were carried out at 1500 bar (Microfluidizer M-110EH; Microfluidics Corp.). The homogenate was centrifuged (Sorvall RC-5B, GSA Rotor, 250 ml centrifuge beaker, 60 minutes, 4° C., 12 000 rpm, 23 000 g), the supernatant was put on ice and the pellet was resuspended in 100 ml of sodium phosphate buffer, pH 7.5. Centrifugation and resuspension were repeated three times, the sodium phosphate buffer comprising 1% SDS at the third repeat. After resuspension, the solution was stirred for one hour, followed by a final centrifugation (Sorvall RC-5B, GSA Rotor, 250 ml centrifuge beaker, 60 minutes, 4° C., 12 000 rpm, 23 000 g). According to SDS-PAGE analysis, the hydrophobin is present in the supernatant after the final centrifugation (FIG. 1). The experiments show that hydrophobin is present in the corresponding E. coli cells probably in the form of inclusion bodies. 50 ml of the hydrophobin-containing supernatant were applied to a 50 ml nickel-Sepharose High Performance 17-5268-02 column (Amersham) equilibrated with 50 mM Tris-Cl buffer, pH 8.0. The column was washed with 50 mM Tris-Cl buffer, pH 8.0, and the hydrophobin was subsequently eluted with 50 mM Tris-Cl buffer, pH 8.0, comprising 200 mM imidazole. For the purpose of removing the imidazole, the solution was dialyzed against 50 mM Tris-Cl buffer, pH 8.0.

FIG. 1 depicts the purification of the hydrophobin HP1 thus prepared:

Lane 1: solution applied to nickel-Sepharose column (1:10 dilution)
Lane 2: flow-through =eluate of washing step
Lanes 3-5: OD 280 peaks of elution fractions

The hydrophobin of FIG. 1 has a molecular weight of approx. 53 kD. Some of the smaller bands represent degradation products of hydrophobin.

### EXAMPLE 9

### Performance testing; characterization of the hydrophobin HP1 by changing the contact angle of a water droplet on glass

### Substrate:

Glass (window glass, Süddeutsche Glas, Mannheim, Germany):
Hydrophobin concentration: 100 mg/l
Incubation of glass slides for 15 hours (temperature 80° C.) in 50 mM sodium acetate (pH 4)+0.1% by weight of polyoxyethylene(20) sorbitan monolaurate in water followed by coating, washing in distilled water
followed by incubation: 10 min/80° C./1% by weight of aqueous sodium n-dodecyl sulfate solution (SDS)
washing in distilled water

The samples thus obtainable were air dried (room temperature) and subjected at room temperature to a determination of the contact angle (in degrees) of a droplet of 5 μl of water.

The contact angle measurement was determined on a Dataphysics Contact Angle System OCA 15+, Software SCA 20.2.0. (November 2002). The measurement was carried out in accordance with the manufacturer's instructions.

Untreated glass gave a contact angle of 30±5°; a coating with the functional hydrophobin of Example 8 (yaad-dewA-his₆) gave contact angles of 67±5°.

### Part B:

### Use of the Hydrophobin HP1 for Coating Surfaces of Fibrous Substrate

A solution of the hydrophobin prepared as described in Example 8 (fusion protein) HP1 (yaad-Xa-dewA-his) (SEQ ID NO: 19) in water was used in the use testing. Concentration of the hydrophobin HP1 in solution: 100 mg/l (0.02% by weight).

### B.1 Inventive Coating of Textile Substrate:

White woven polyester fabric, basis weight 226 g/m², was initially rinsed for 45 minutes with completely ion-free water and then dipped into a 0.02% by weight aqueous solution of HP1 in water and treated at 80° C. for 17 hours. Thereafter, the polyester fabric thus treated was rinsed with completely ion-free water for one minute and dried at room temperature to obtain inventively treated substrate PES-HP1. It had a very pleasant hand.

### B.2 Inventive Coating of Textile Substrate

B.1 was repeated, except that the treatment was carried out at room temperature and not at 80° C.

The inventively treated substrate PES-HP2 was obtained. It had a very pleasant hand.

Soil used:

The following were used as soil for the tests:

### Triolein

### Lipstick

Used engine oil

A plurality of inventively treated substrates PES-HP1 were each soiled with one of the abovementioned soils for 18 hours using about 0.1 g of soil per dm².

### Preparation of a Test Washing Composition and Washing of Inventive PES-HP1

The following were mixed together:

5 g of sodium n-dodecylbenzenesulfonate
5 g of a C₁₃-C₁₅ oxo process alcohol mixture ethoxylated with on average
7 equivalents of ethylene oxide/mol
5.8 g of 40% by weight aqueous solution of a random copolymer of acrylic acid (70% by weight) and maleic acid (30% by weight), neutralized with NaOH, pH 7.9, M_{w} 70 000 g/mol.
1.4 g of curd soap
1.2 g of Tylose CR 1500 p carboxymethylcellulose

### 14 g of Na₂CO₃

30 g of zeolite A
21 g of sodium perborate tetrahydrate
6 g of tetrasodium ethylenediaminetetraacetate
3.6 g of sodium metasilicate pentahydrate

### 7 g of Na₂SO₄

to obtain the test washing composition 1.

Inventively treated and thereafter soiled PES-HP1 samples were washed in a Launder-O-Meter from Atlas, USA, using 3 prewash cycles and one main wash cycle. The water used had a hardness of 3 mmol/l (Ca:Mg:HCO₃ 4:1:8), liquor ratio 12.5:1, dosage 4.5 g of test washing composition 1/l, water temperature 40° C. Total wash time: 30 minutes.

Triolein and engine oil soiling were completely removed, lipstick residues were extremely slight and only visible under a magnifying glass.

Assignment of sequence names to DNA and polypeptide sequences in sequence listing

| | |
|---|---|
| dewA DNA and polypeptide sequences | SEQ ID NO: 1 |
| dewA polypeptide sequence | SEQ ID NO: 2 |
| rodA DNA and polypeptide sequences | SEQ ID NO: 3 |
| rodA polypeptide sequence | SEQ ID NO: 4 |
| hypA DNA and polypeptide sequences | SEQ ID NO: 5 |
| hypA polypeptide sequence | SEQ ID NO: 6 |
| hypB DNA and polypeptide sequences | SEQ ID NO: 7 |
| hypB polypeptide sequence | SEQ ID NO: 8 |
| sc3 DNA and polypeptide sequences | SEQ ID NO: 9 |
| sc3 polypeptide sequence | SEQ ID NO: 10 |
| basf1 DNA and polypeptide sequences | SEQ ID NO: 11 |
| basf1 polypeptide sequence | SEQ ID NO: 12 |
| basf2 DNA and polypeptide sequences | SEQ ID NO: 13 |
| basf2 polypeptide sequence | SEQ ID NO: 14 |
| yaad DNA and polypeptide sequences | SEQ ID NO: 15 |
| yaad polypeptide sequence | SEQ ID NO: 16 |
| yaae DNA and polypeptide sequences | SEQ ID NO: 17 |
| yaae polypeptide sequence | SEQ ID NO: 18 |
| yaad-Xa-dewA-his DNA and polypeptide | SEQ ID NO: 19 |
| sequences | |
| yaad-Xa-dewA-his polypeptide sequence | SEQ ID NO: 20 |
| yaad-Xa-rodA-his DNA and polypeptide | SEQ ID NO: 21 |
| sequences | |
| yaad-Xa-rodA-his polypeptide sequence | SEQ ID NO: 22 |
| yaad-Xa-basf1-his DNA and polypeptide | SEQ ID NO: 23 |
| sequences | |
| yaad-Xa-basf1-his polypeptide sequence | SEQ ID NO: 24 |

1. A process for coating textile substrates selected from the group consisting of polyacrylonitrile, polyamide, polyester and blends of materials of natural origin with polyacrylonitrile, polyamide or polyester comprising contacting the textile substrate with at least one aqueous formulation comprising at least one hydrophobin.

2. (canceled)

3. The process according to claim 1 conducted in a pad mangle.

4. The process according to claim 1, wherein the at least one aqueous formulation comprises at least one hydrophobin in the range from 1 mg/l to 10 g/l.

5. The process according to claim 1, wherein the textile substrate is pretreated and then contacted with hydrophobin.

6. The process according to claim 1, wherein the contacting of the textile substrate with hydrophobin is followed by drying at temperatures in the range from 20 to 120° C.

7. A textile substrate coated according to claim 1.

8. Garments, home textiles or industrial textiles produced by using at least one textile substrate according to claim 7.

9. (canceled)
